(19) United States
(12) Patent Application Publication
(10) Pub. No.: US 2012/0009495 A1
(43) Pub. Date: Jan. 12, 2012

(54) CONCENTRATION SENSOR USING AN ELECTROLYTIC CELL FOR AQUEOUS HYDROCARBON FUEL

(75) Inventors: Suk-Yal Cha, Fremont, CA (US); David Ridley, Fremont, CA (US); Joseph Stark, Fremont, CA (US); Derek Kwok, Fremont, CA (US)

(73) Assignee: OORJA PROTONICS INC., Fremont, CA (US)

(21) Appl. No.: 13/178,384

(22) Filed: Jul. 7, 2011

Related U.S. Application Data
(60) Provisional application No. 61/362,419, filed on Jul. 8, 2010.

(51) Int. Cl. G01N 27/416; H01M 8/24; G01N 27/40

(52) U.S. Cl. 429/454; 204/415

(57) ABSTRACT

A concentration sensor assembly for measuring a concentration of a aqueous hydrocarbon fuel to be supplied to a fuel cell stack, the assembly including a membrane electrode assembly having an anode, a cathode and an electrolyte membrane located between the anode and the cathode; a first monopolar flow field plate provided near the anode; a second monopolar flow field plate provided near the cathode; and a liquid gas separator.

### CROSS REFERENCE TO RELATED APPLICATION

This application claims priority to U.S. Provisional Application No. 61/362,419, filed on Jul. 8, 2010, the complete disclosure of which is incorporated fully herein by reference.

### TECHNICAL FIELD

The embodiments herein generally relate to a concentration sensor assembly and more particularly, but not exclusively to a concentration sensor assembly using an electrolytic cell for measuring concentration of aqueous hydrocarbon fuel supplied to fuel cell.

### BACKGROUND

Direct liquid feed fuel cell exhibits high energy and power density and hence the demand for such fuel cells has increased. A direct liquid feed fuel cell generates electrical power by the electrochemical reactions between a fuel and an oxidizing agent. An aqueous hydrocarbon fuel such as methanol or ethanol may be used as a fuel for the direct liquid feed fuel cell.

An exemplary direct liquid feed fuel cell has an anode, a cathode, an electrolyte interposed between the anode and the cathode. In fuel cells, electricity is produced from the electrochemical reactions which take place at the anode and the cathode. At the anode, hydrocarbon fuel is electrochemically oxidized with water to produce electrons, protons and carbon dioxide. The electrons travel through an external electronic circuit to the cathode. At the cathode, oxygen from air electrochemically reacts with electrons and protons, which migrate through the electrolyte from the anode to cathode. During continuous electrochemical reactions, the electron passage through the external load may be used as an energy source for electronic devices. Further, the exothermic electrochemical reaction at the cathode may be an energy source for heat driven devices or devices which convert heat energy to electrical energy.

Further, the electrolyte used in the direct liquid feed fuel cell can be an acid or a base. A proton exchange membranes such as a perfluorosulfonic acid (PFSA) membrane may be used as an electrolyte for the fuel cell. Specifically, perfluorosulfonic acid membrane is used as an electrolyte in a direct methanol fuel cell (DMFC). A DMFC system has a fuel tank storing concentrated or pure methanol, and supplies a mixture of methanol and water as fuel to the anode. The methanol or hydrocarbon fuel can crossover (a phenomenon in which fuel passes through the membrane) through a PFSA membrane if the concentration of methanol or the fuel is high in the mixture. This fuel crossover increases as a function of temperature, concentration of aqueous fuel, and thickness of PFSA membrane. For example, higher operating temperature, higher fuel concentration, and thinner (or higher conductance) membrane increase the fuel crossover rate. The higher fuel crossover causes negative effects on fuel utilization, performance, and durability. For this reason, POLYFUEL and TORAY have developed hydrocarbon membranes to lower fuel crossover.

As may be inferred from the above discussion, fuel concentration is one of the important factors affecting the performance of a fuel cell. Therefore, controlling the fuel concentration is necessary to ensure optimum performance and proper fuel utilization by the fuel cell.

Many methods are being used to determine the concentration of fuel in the mixture which is fed to the fuel cell. In one such method, small amount of the fuel of a fuel cell is separated and heated until boiling, and the boiling point is measured to determine the fuel concentration. In another method, the concentration of the fuel is determined based on the viscosity of the liquid fuel.

Furthermore, fuel concentration sensors are also being used to determine the concentration of the fuel in the mixture. However, conventional fuel concentration sensors are bulky and inefficient. Other sensor technologies require immersion into aqueous fuel solutions. The materials required to avoid corrosion and related contamination are quite expensive, resulting in very expensive sensors.

Therefore, there is a need for a concentration sensor assembly which could obviate the problems of the conventional sensors and which can be integrated with a direct methanol fuel cell and system.

### SUMMARY

In view of the foregoing, an embodiment herein provides a concentration sensor assembly for measuring a concentration of an aqueous hydrocarbon fuel to be supplied to a fuel cell stack. The concentration sensor assembly includes a membrane electrode assembly having an anode, a cathode and a electrolyte membrane located between said anode and said cathode, a first monopolar flow field plate provided near said anode, a second monopolar flow field plate provided near said cathode and a liquid gas separator.

Embodiments further disclose a concentration sensor assembly for measuring a concentration of an aqueous hydrocarbon fuel to be supplied to a fuel cell stack. The concentration sensor assembly includes a membrane electrode assembly having an anode, a cathode and a electrolyte membrane located between said anode and said cathode, a first monopolar flow field plate provided near said anode, a second monopolar flow field plate provided near said cathode and a water pressure controllable gas diffusion layer. Embodiments herein also disclose a concentration sensor assembly integrated with a fuel cell stack. The concentration sensor assembly integrated in the fuel cell stack includes an anode connected to a first current collector, a cathode connected to a second current collector. Further, the assembly includes a membrane electrode assembly provided between the anode and the cathode. The membrane electrode assembly is a portion of a membrane electrode assembly of the fuel cell.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 shows a concentration sensor assembly for measuring fuel concentration according to an embodiment;

FIG. 1A shows a membrane electrode assembly (MEA) which may be employed in the concentration sensor assembly according to an embodiment

FIG. 2 shows a MEA integrated with water pressure control capable gas diffusion according to an embodiment;

FIG. 2A shows the water pressure control capable gas diffusion media according to the embodiment of FIG. 2;

FIG. 3 shows a concentration sensor assembly integrated with a membrane electrode assembly of a fuel cell stack according another embodiment;

FIG. 3A shows a cross sectional view of the concentration sensor assembly;

FIG. 4 is a block diagram illustrating the working nature of concentration sensor assembly according to an embodiment;

FIG. 5 is a chart illustrating the relation of concentration of methanol, current, and temperature with a proton conductive hydrocarbon membrane employed electrolytic cell;

FIG. 6 is chart showing estimated methanol concentration c;

FIG. 7 is a chart illustrating flow rate sensitivity with a commercial and the present invention sensors;

FIG. 8 is a chart illustrating relative responding time with methanol concentration variation; and

FIG. 9 is a chart showing sensor batch variation.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

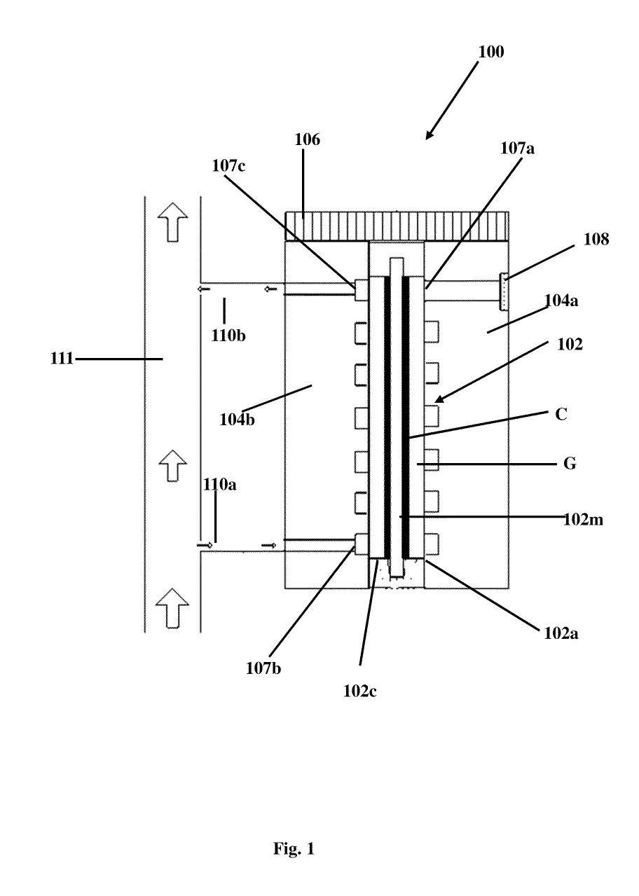

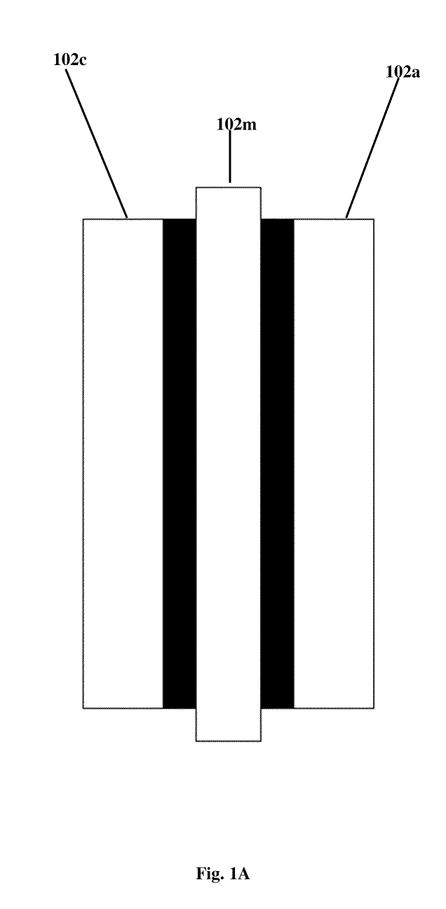

The embodiments herein disclose a concentration sensor assembly 100 for measuring the concentration of hydrocarbon fuel which is being supplied to the fuel cell. Referring now to the drawings, and more particularly to FIGS. 1 through 9, where similar reference characters denote corresponding features consistently throughout the figures, there are shown embodiments.

FIG. 1 shows a concentration sensor assembly 100 for measuring fuel concentration according to an embodiment. The concentration sensor assembly 100 includes a membrane electrode assembly (MEA) 102. The membrane electrode assembly 102 has an anode 102a, a cathode 102c and an electrolyte membrane 102m located between the anode 102a and the cathode 102c (also shown in FIG. 1A). Each of the anode 102a and cathode 102c includes a gas diffusion media G and a catalyst layer C. In one embodiment, the membrane electrode assembly 102 may be prepared by providing a catalyst layer C on each of the longitudinal sides of the electrolyte membrane 102m. Thereafter, the gas diffusion media G is attached to the respective catalyst layer C. In an alternate embodiment, each of the gas diffusion media G may be coated with the catalyst layer C and then, the gas diffusion media G and the catalyst layer C may be laminated to the electrolyte membrane 102m. The catalyst layer C may be applied to the electrolyte membrane 102m or to the gas diffusion media G by spraying, screen printing, tape casting, inkjet printing, and mayor rod coating among other methods.

The electrolyte membrane 102m may be a Fluorocarbon membrane, Nafion®, or hydrocarbon membrane, PolyFuel DM-1 or Toray hydrocarbon membrane. The electrolyte membrane 102m is essentially capable of conducting protons. Further, the catalyst layer C may be platinum catalyst or a platinum/ruthenium base catalyst.

Further, the concentration sensor assembly 100 has a first monopolar flow field plate 104a and a second monopolar flow field plate 104b. The first monopolar flow field plate 104a is provided near the anode 102a and the second monopolar flow field plate 104b is provided near the cathode 102c. The first monopolar flow field plate 104a and the second monopolar flow field plate 104b are configured to receive the membrane electrode assembly 102 of the concentration sensor assembly 100 there between.

The concentration sensor assembly 100 may further have a plurality of housing plates (not shown). The housing plates are configured to receive the membrane electrode assembly 102 and the monopolar flow field plates 104a and 104b of the concentration sensor assembly 100. Further, an electronic circuit 106 is provided in the concentration sensor assembly 100. The electronic circuit 106 may be secured to an internal or external surface of one of the housing plates. In one embodiment, the monopolar flow field plates 104a and 104b of the concentration sensor assembly 100 are made of graphite or composite graphite. Each of the monopolar flow field plates 104a and 104b have a pressure drop less than 0.1 psi for varied ranges of aqueous hydrocarbon fuel flow rate. The first monopolar flow field plate 104a defines an opening 107a for releasing byproducts such as carbon dioxide and water vapor. The first monopolar flow field plate 104a further has a liquid water compartment (not shown). Further, the monopolar plate 104b defines at least a first opening 107b and a second opening 107c. The first opening 107b of the monopolar flow field plate 104b is configured to allow the aqueous hydrocarbon fuel to flow into the concentration sensor assembly 100 and the second opening 107c of the monopolar flow field plate 104b is configured to allow passage of byproducts including hydrogen or the un-reacted hydrocarbon fuel out of the concentration sensor assembly 100.

The anode 102a and the cathode 102c are connected to a positive terminal and a negative terminal, respectively, of an external power supply. Further, a register (not shown) is connected to the anode 102a and the cathode 102c to record or register current. Further, the register also measures and records the temperature in the concentration sensor assembly 100 and to this effect, a temperature sensor (not shown) is also provided in the concentration sensor assembly 100. The power supply is configured to deliver a constant voltage of around 0.5˜0.8V depending on a type of the catalyst used in the catalyst layer C. For example, if platinum/ruthenium base catalyst is employed for the anode 102a, the applied voltage from a power supply is typically less than 0.6V. Further, if platinum catalyst is employed for anode 102a, the applied voltage is 0.8V which may be sufficient to electrochemically oxidize hydrocarbon fuel at the anode 102a.

Further, in one embodiment, the concentration sensor assembly 100 may have a liquid gas separator 108 located near the first monopolar flow field plate 104a. The liquid gas separator 108 is in fluid communication with the anode 104a through the opening 107a defined by the first monopolar flow field plate 104a. The liquid gas separator 108 facilitates separation of liquid and gas. The liquid gas separator 108 is located between anode 102a and the housing plate adjacent to anode 102a. It is also within the scope of the invention to provide liquid gas separator 108 in any other location without otherwise deterring the overall function of the liquid gas separator as explained in the description. The liquid gas separator 108 may be a layer of porous hydrophobic material having a pore size less than about 100 microns and made of polytetrafluoroethylene (PTFE) or composite material with polytetrafluoroethylene (PTFE) and porous media such as polymer, metal, metaloxide, carbon paper or cloth and the like. The content of polytetrafluoroethylene (PTFE) in composite materials may be 5˜100%.

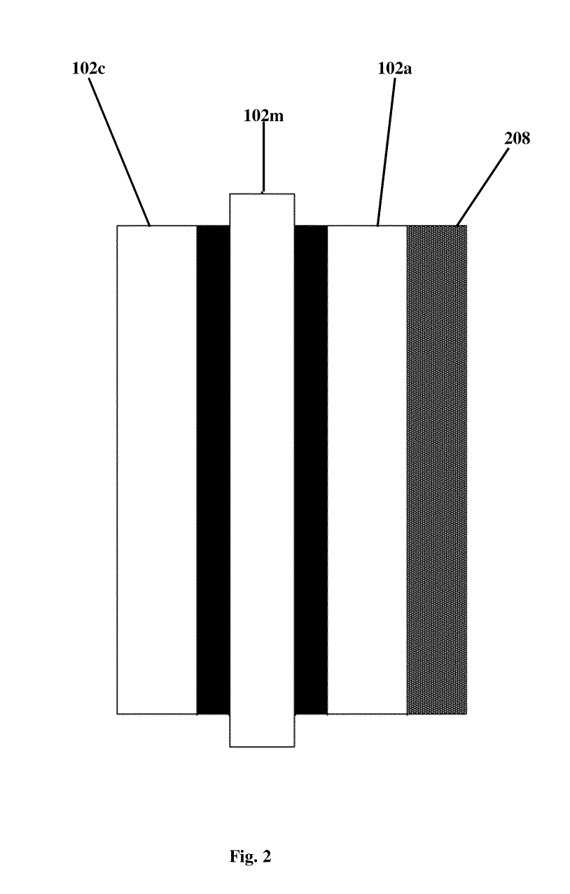

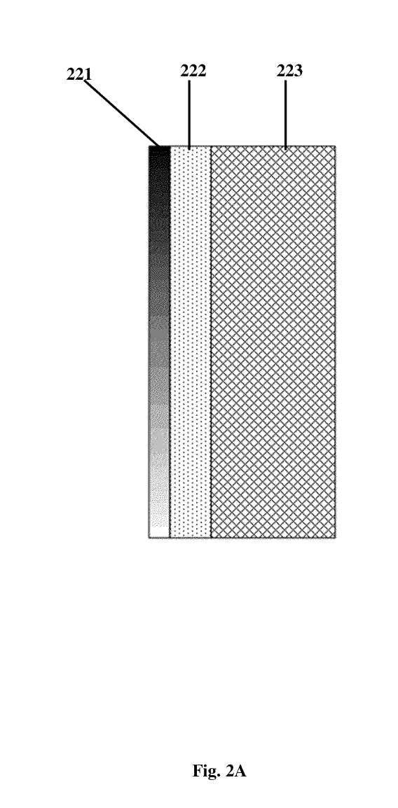

In an alternate embodiment, as shown in FIG. 2, a water pressure controllable gas diffusion media 208 may be provided near the anode 104a. Providing the water pressure controllable gas diffusion media 208 near the cathode 104b is also within the scope of this invention. The water pressure controllable gas diffusion media 208 facilitates release of byproducts such as water and carbon dioxide to ambient. Further, it is also within the scope of the invention to use water pressure controllable gas diffusion media 208 in place of liquid gas separator 108 to enable diffusion of the carbon dioxide.

Further, as shown in FIG. 2A, the water pressure controllable gas diffusion media 208 includes a hydrophilic porous layer 221, a gas permeable water capillary pressure control layer 222 and a porous gas diffusion layer 223. The hydrophilic porous layer 221 enables retention of water. In one embodiment, one of the catalyst layer C may act as the hydrophilic layer. The gas permeable water capillary pressure control layer 222 is a dense micro porous layer having a plurality of pores. The mean pore diameter of the pores in the gas permeable water capillary pressure control layer 222 facilitates in controlling a liquid pressure. The water capillary pressure of the gas permeable water capillary pressure control layer 222 is about 1.1 to 6 atm. the gas permeable water capillary pressure control layer 222 can be made from the mixture of graphite, carbon black and polytetrafluoroethylene (PTFE) or polyfluoroethylenepropylene (PFEP). The mixture of graphite, carbon black and polytetrafluoroethylene (PTFE) resin is coated onto a polytetrafluoroethylene (PTFE) treated carbon paper or a cloth by spraying, tape casting, screen printing or mayer rod casting and is sintered at 250˜350° C. Further, the porous gas diffusion layer 223 is a polytetrafluoroethylene (PTFE) treated carbon paper or a carbon cloth. The porous gas diffusion layer 223 facilitates passage of water and gas. The porous gas diffusion layer 223, when subject to an hydrophobic treatment and polytetrafluoroethylene (PTFE), enables permeation of gas without flooding.

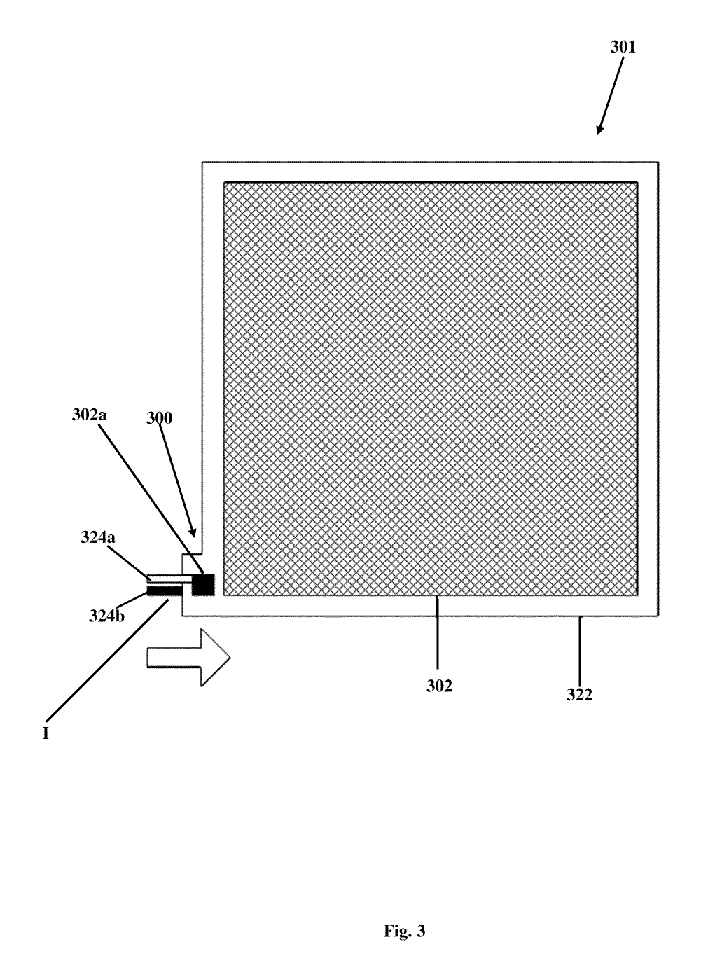

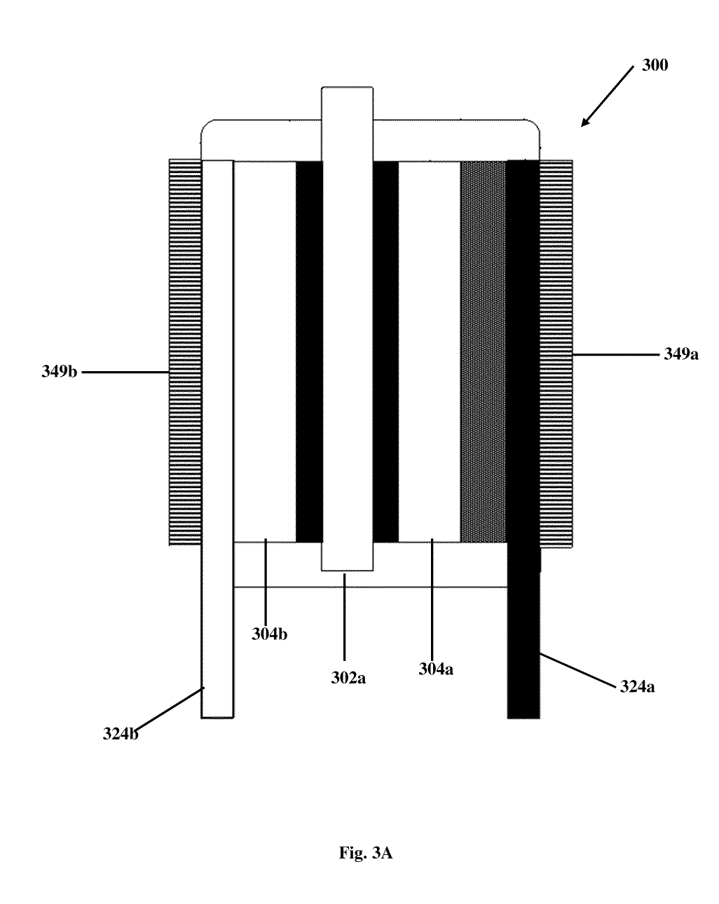

FIG. 3 shows a concentration sensor assembly 300 integrated with a membrane electrode assembly 302 of a fuel cell stack 301 according another embodiment. The membrane electrode assembly 302 is used for fuel cell application and a portion 302a of the membrane electrode assembly 302 is used for concentration sensor application. The portion 302a of the membrane electrode assembly 302 acts as a membrane electrode assembly for concentration sensor assembly 300. The fuel cell stack 301 has an edge area 322 which is configured to accommodate membrane electrode assemblies 302 and 302a. Further the edge area 322 facilitates sealing of the fuel cell stack 301 and the concentration sensor assembly 300. Further, a first current collector 324a is secured to the anode 304a of the membrane electrode assembly 302a. Similarly, a second current collector 324b is secured to the cathode 304b of the membrane electrode assembly 302a.

From the above description regarding the embodiments of FIG. 3 it is important to note that the concentration sensor assembly 300 may be a separate sensor assembly integrated with the fuel cell stack 301 or the concentration sensor assembly 300 may share portions of membrane electrode assembly 302, bipolar or monopolar plates of the fuel cell stack 301. The concentration sensor assembly 300 according to this embodiment may be located between anode and cathode bipolar plates of the fuel cell stack 301. It should also be noted that the concentration sensor assembly of FIG. 3 should be located at the anode inlet I of the fuel cell stack 300 in order to ensure that the measurement of a concentration of an aqueous hydrocarbon solution is done prior to the concentration change by fuel cell anodic reaction. Therefore, any modifications as noted above in this and previous paragraphs are also within the scope of the present invention.

FIG. 3A shows a cross sectional view of the concentration sensor assembly 300. The concentration sensor assembly 300 of this embodiment is similar to the concentration sensor assembly 100 of the embodiment as disclosed earlier with respect to FIG. 1 except that in the instant embodiment the first current collector 324a, the second current collector 324b, a first electrical insulator 349a and a second current collector 349b are provided. As disclosed earlier, the first current collector 324a is secured to the anode 304a of the membrane electrode assembly 302a. Similarly, the second current collector 324b is secured to the cathode 304b of the membrane electrode assembly 302a. Each of the first and second current collectors 324a and 324b is a non-corrosive metal mesh which allows transfer of hydrocarbon solution, carbon dioxide, hydrogen and electrons. In an embodiment, each of the first and second current collectors 324a and 324b are coated with non-corrosive metal such as gold, silver, platinum, titanium nitride and the like.

Further, the first electrical insulator 349a is provided near the anode 304a and a second current collector 349b is provided near the cathode 304b. Each of the electrical insulators 349a and 349b are made of electrically non-conductive polymers or ceramics such as polytetra fluoroethylene (PTFE), polyvinyledenefluoride (PVdF), EPOXY, silicone oxide, yttria-stabilized zirconia oxide (YSZ). Further, it should be noted that the electrical insulators 349a and 349b may be deposited onto either bipolar plates of the fuel cell (not shown) or on an outer side of the respective current collectors 324a and 324b.

In general, the electrochemical reactions at anode 102a and cathode 102c using hydrocarbon fuel are described in following equations 1 and 2. Further, the overall reaction inside the concentration sensor assembly 100 is provided in equation 3.

Anode (102a): CxHyOz+nH2O xCO2+(y+2n)H++(y+2n)e− (1)

Cathode (102c): (y+2n)H++(y+2n)e−(y/2+n)H2 (2)

Concentration sensor (100): CxHyOz+nH2O xCO2+(y/2+n)H2. (3)

The byproduct, carbon dioxide, at the anode 102a should be vent to ambient so that the catalyst layer C at the anode 102a is maintained under a constant flooded condition, and has no interference from the gaseous byproduct such as carbon dioxide. To achieve the gas separation, a membrane with hydrophobic pores can be used. It should be noted that the anode catalyst layer C should be hydrophilic to prevent membrane electrode assembly 102 from drying out and to further prevent decrease in the hydraulic pressure of liquid water. An aqueous hydrocarbon fuel supplied to the cathode 102c diffuses through the electrolyte membrane 102m to the catalyst layer C of the anode 102a. Flow of the fuel solution to the concentration sensor assembly 100 may be achieved by passively bypassing a small quanity of the fuel from a main fuel stream 111 (as shown in FIG. 1) using a smaller diameter pipe 110a.

Further, the passively bypassed aqueous hydrocarbon fuel flows to the cathode 102c. The aqueous hydrocarbon fuel (hydrocarbon and water) diffuses through electrolyte membrane 102m to the anode 102a. The diffused aqueous hydrocarbon is electrochemically oxidized at the anode 102a generating free electrons, protons and carbon dioxide. The electrochemical oxidation of the diffused aqueous hydrocarbon fuel is facilitated by the external power supply, which is integrated with an electronic circuit 106. At the cathode 102c, protons are reduced to hydrogen. To achieve the electrochemical hydrogen generation, therefore, the anode 102a and the cathode 102c are electrically connected to positive and negative terminals of the external power supply, respectively. The carbon dioxide is released through a liquid gas separator 108 or water pressure controllable gas diffusion 208.

The byproduct hydrogen from the cathode is merged with the main fuel stream 111. Thereafter, the aqueous hydrocarbon fuel which will be fed to the fuel cell will contain less than 0.1 wt % hydrogen gas.

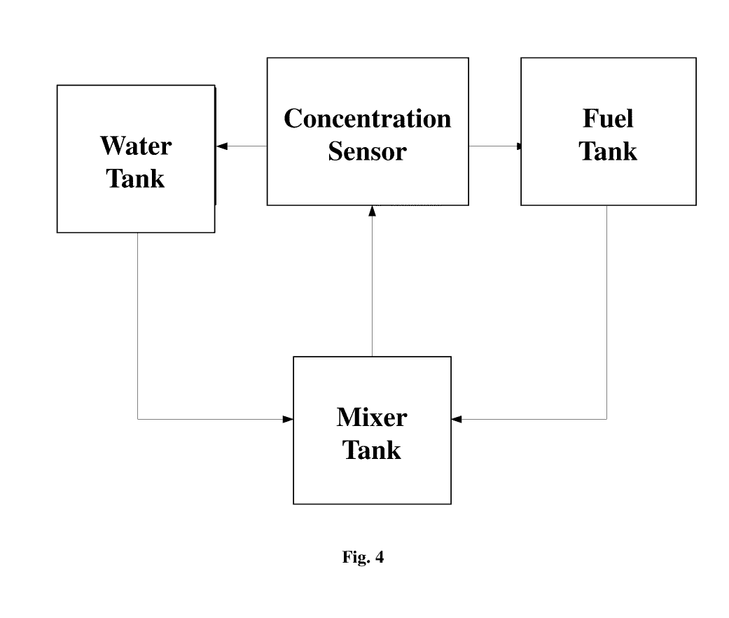

FIG. 4 is a block diagram illustrating the working nature of concentration sensor assembly 100 according to an embodiment. Mixer tank is a container for methanol/water solution, which is supplied to the anodes of the fuel cell stack as a fuel. As the fuel cell stack consumes methanol/water generating electrical energy, the concentration of methanol solution in the mixer tank is changed. Concentration sensor detects a concentration and send signals to the pumps for water and fuel tanks in order to sustain a proper concentration of methanol/water solution in mixer tank.

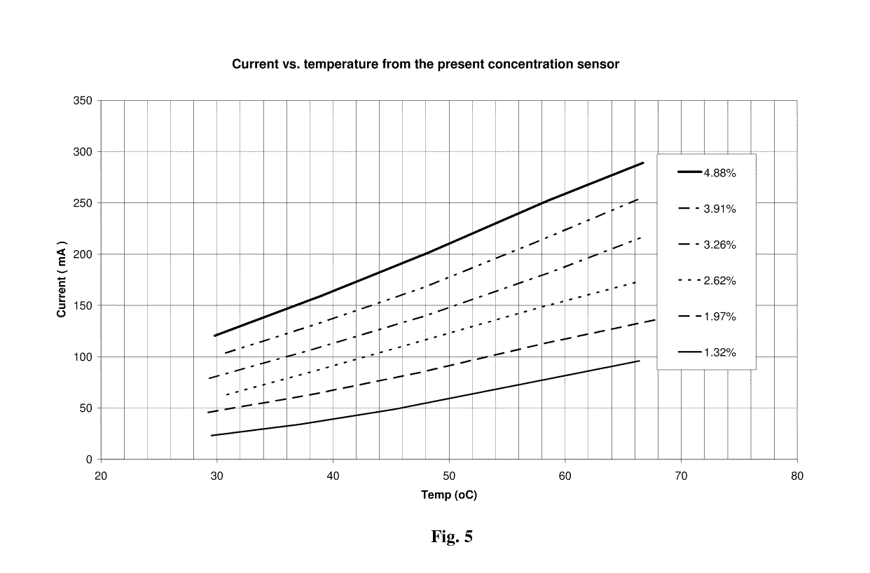

FIG. 5 is a chart illustrating the relation of concentration of methanol, current, and temperature with a proton conductive hydrocarbon membrane employed electrolytic cell. Known concentrations of methanol/water solution are evaluated at the various temperatures from 30 to 65° C., 15 cc/min of the solution flow rate in order to measure methanol crossover current. This chart is used to back-calculate unknown methanol concentration from measured current and temperature.

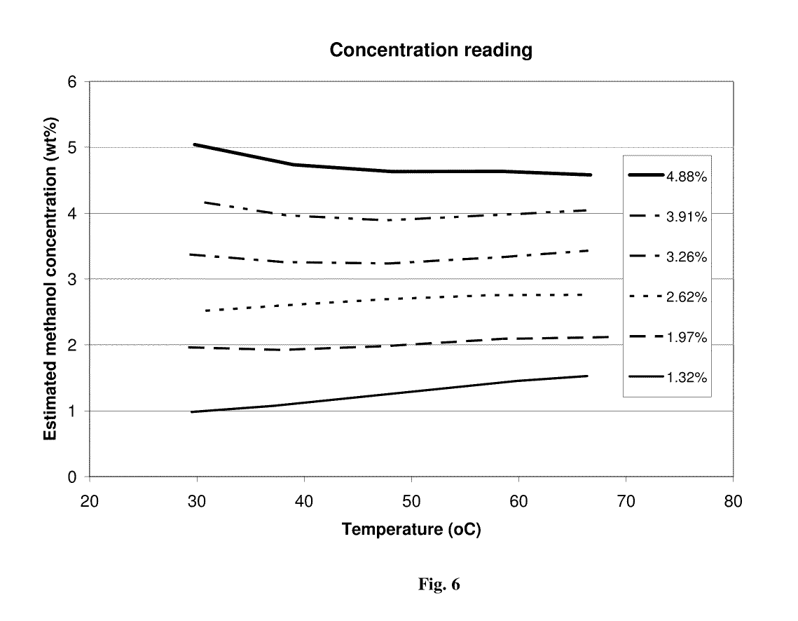

FIG. 6 is chart showing estimated methanol concentration.

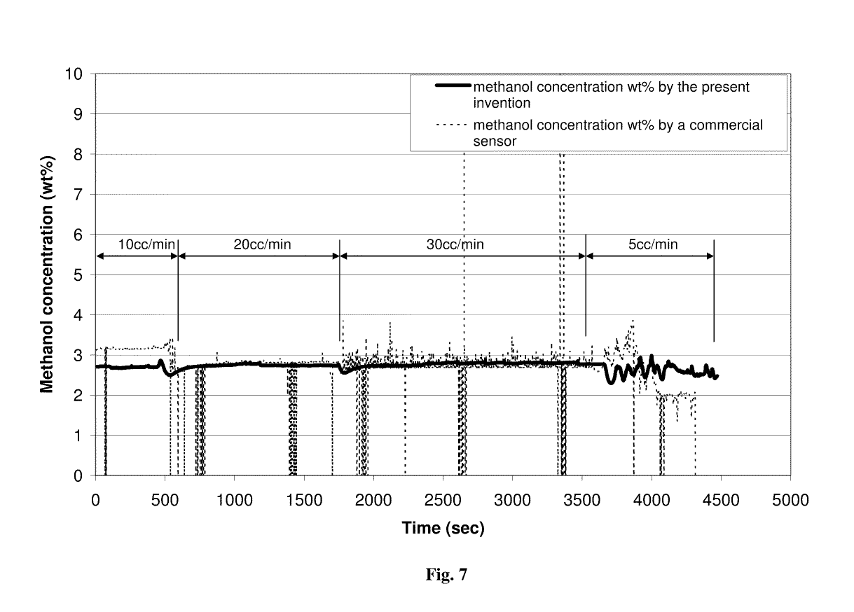

FIG. 7 is a chart illustrating flow rate sensitivity with a commercial and the present invention sensors. The concentration sensor assembly 100/300 according to the embodiments described herein shows excellent flow rate sensitivity at 10˜30 cc/min.

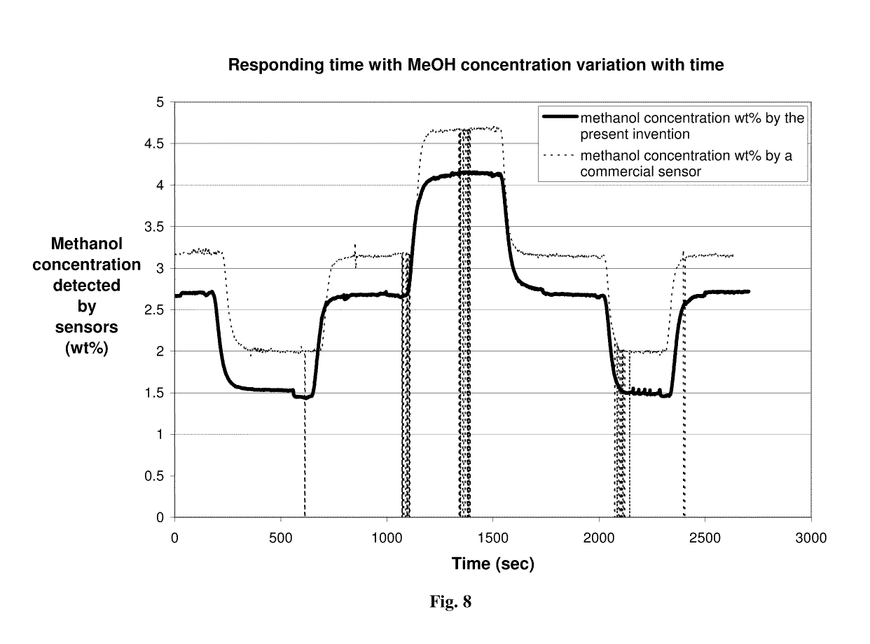

FIG. 8 is a chart illustrating relative responding time with methanol concentration variation.

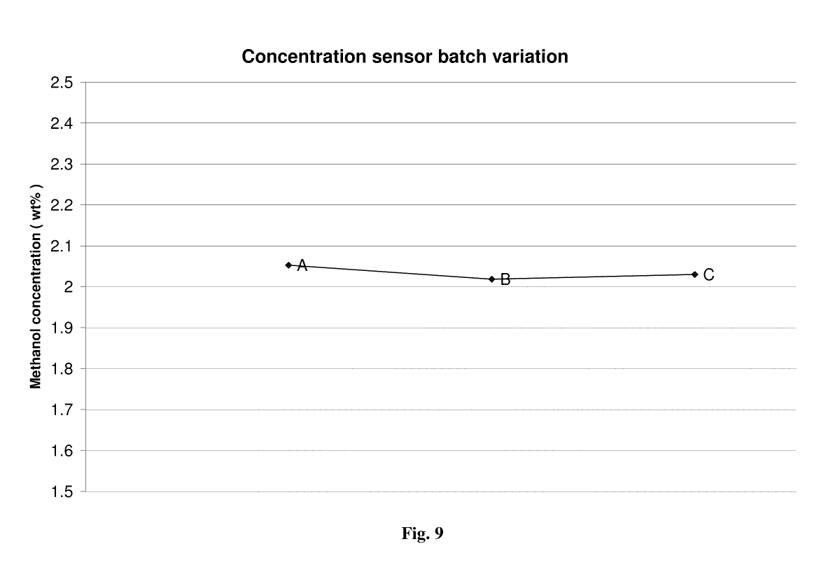

FIG. 9 is a chart showing sensor batch variation.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A concentration sensor assembly for measuring a concentration of a aqueous hydrocarbon fuel to be supplied to a fuel cell stack, said assembly comprising:
a membrane electrode assembly having an anode, a cathode and an electrolyte membrane located between said anode and said cathode;
a first monopolar flow field plate provided near said anode;
a second monopolar flow field plate provided near said cathode; and
a liquid gas separator.

2. The concentration sensor assembly as claimed in claim 1, wherein each of said anode and said cathode includes a catalyst layer and a gas diffusion layer.

3. The concentration sensor assembly as claimed in claim 2, wherein the catalyst layer is at least one of platinum and ruthenium.

4. The concentration sensor assembly as claimed in claim 1, wherein said first monopolar flow field plates defines an opening to for releasing byproducts such as carbon dioxide and water vapor and to establish a fluid communication with said liquid gas separator.

5. The concentration sensor assembly as claimed in claim 1, wherein said liquid gas separator is positioned between said anode and a housing element, said housing element configured to receive said concentration sensor assembly.

6. The concentration sensor assembly as claimed in claim 1, wherein liquid gas separator is a layer of porous hydrophobic material, said porous hydrophobic material having a plurality of pores with size less than 100 microns.

7. The concentration sensor assembly as claimed in claim 5 further comprises an electronic circuit to measure current and a temperature sensor to measure temperature in the concentration sensor assembly.

8. The concentration sensor assembly as claimed in claim 1, wherein each of said first and second monopolar flow field plates is one of graphite and composite graphite.

9. The concentration assembly as claimed in claim 4, wherein said second monopolar flow field plate defines at least two openings for allowing passage of a bypassed aqueous hydrocarbon fuel to and from said concentration sensor assembly to a main fuel stream connected to the fuel cell stack.

10. A concentration sensor assembly for measuring a concentration of a aqueous hydrocarbon fuel to be supplied to a fuel cell stack, said assembly comprising:
a membrane electrode assembly having an anode, a cathode and an electrolyte membrane located between said anode and said cathode;
a first monopolar flow field plate provided near said anode;
a second monopolar flow field plate provided near said cathode; and
a water pressure controllable gas diffusion layer.

11. The concentration sensor assembly as claimed in claim 10, wherein each of said anode and said cathode includes a catalyst layer and a gas diffusion layer.

12. The concentration sensor assembly as claimed in claim 11, wherein the catalyst layer is at least one of platinum and ruthenium.

13. The concentration assembly as claimed in claim 10, wherein water pressure controllable gas diffusion layer further comprises a hydrophilic porous layer, a gas permeable water capillary pressure control layer and a porous gas diffusion layer.

14. The concentration assembly as claimed in claim 10, wherein said a water pressure controllable gas diffusion layer has a plurality of pores with size less than 100 micro meter.

15. The concentration sensor assembly as claimed in claim 10, wherein each of said first and second monopolar flow field plates is one of graphite and composite graphite.

16. The concentration assembly as claimed in claim 10, wherein said second monopolar flow field plate defines at least two openings for allowing passage of a bypassed aqueous hydrocarbon fuel to and from said concentration sensor assembly to a main fuel stream connected to the fuel cell stack.

17. A concentration sensor assembly for measuring a concentration of a aqueous hydrocarbon fuel to be supplied to a fuel cell stack, said assembly being integrated in the fuel cell stack, said assembly comprising:
an anode connected to a first current collector;
a cathode connected to a second current collector; and
a membrane electrode assembly provided between said anode and said cathode, said membrane electrode assembly being a portion of a membrane electrode assembly of said fuel cell.

18. The concentration sensor assembly as claimed in claim 17, wherein said anode is a portion of an anode of said fuel cell.

19. The concentration sensor assembly as claimed in claim 17, wherein said cathode is a portion of a cathode of said fuel cell.

20. The concentration sensor assembly as claimed in claim 17, wherein each of said first and second current collector is a non-corrosive metal.
